(19) United States
(12) Patent Application Publication
(10) Pub. No.: US 2018/0063854 A1
(43) Pub. Date: Mar. 1, 2018

(54) ACKNOWLEDGEMENT MESSAGE PRIORITIZATION

(71) Applicant: QUALCOMM Incorporated, San Diego, CA (US)

(72) Inventors: Sitaramanjaneyulu KANAMARLAPUDI, San Diego, CA (US); Aziz GHOLMIEH, Del Mar, CA (US); Liangchi HSU, San Diego, CA (US)

(21) Appl. No.: 15/690,996

(22) Filed: Aug. 30, 2017

Related U.S. Application Data
(60) Provisional application No. 62/381,198, filed on Aug. 30, 2016.

(51) Int. Cl. H04W 72/10; H04L 5/00; H04W 72/04

(52) U.S. Cl. CPC H04W 72/10; H04W 16/32; H04W 72/044; H04L 5/0055

(57) ABSTRACT

Various aspects are described herein. In some aspects, the present disclosure provides a method for communicating in a wireless communication network. The method includes transmitting a message. The method further includes receiving a control protocol data unit (PDU) including a payload, the payload including an acknowledgement service data unit (SDU) of the transmitted message, in response to transmitting the message. The method further includes processing the control PDU at a lower layer based on a priority of the control PDU, wherein the priority of the control PDU is above a priority of data PDUs. The method further includes determining, based on the processing of the control PDU at the lower layer, that the payload of the control PDU includes an acknowledgement SDU. The method further includes forwarding the acknowledgement SDU to a higher layer, bypassing the lower layer. The method further includes processing the acknowledgment SDU at the higher layer.

### CROSS-REFERENCE TO RELATED APPLICATIONS

This application claims the benefit of U.S. Provisional Patent No. 62/381,198, filed Aug. 30, 2016. The content of the provisional application is hereby incorporated by reference in their entirety.

### TECHNICAL FIELD

The present disclosure relates generally to communication systems, and more particularly, to acknowledgement message prioritization for wireless communication.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include Long Term Evolution (LTE) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

In some examples, a wireless multiple-access communication system may include a number of base stations, each simultaneously supporting communication for multiple communication devices, otherwise known as user equipment (UEs). In LTE or LTE-A network, a set of one or more base stations may define an e NodeB (eNB). In other examples (e.g., in a next generation or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., a new radio base station (NR BS), a new radio node-B (NR NB), a network node, 5G NB, gNB, gNodeB, eNB, etc.). A base station or DU may communicate with a set of UEs on downlink channels (e.g., for transmissions from a base station or to a UE) and uplink channels (e.g., for transmissions from a UE to a base station or distributed unit).

These multiple access technologies have been adopted in various telecommunication standards to provide a common protocol that enables different wireless devices to communicate on a municipal, national, regional, and even global level. An example of an emerging telecommunication standard is new radio (NR), for example, 5G radio access. NR is a set of enhancements to the LTE mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL) as well as support beamforming, multiple-input multiple-output (MIMO) antenna technology, and carrier aggregation.

However, as the demand for mobile broadband access continues to increase, there exists a need for further improvements in NR technology. Preferably, these improvements should be applicable to other multi-access technologies and the telecommunication standards that employ these technologies.

### BRIEF SUMMARY OF SOME EXAMPLES

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

In some aspects, the present disclosure provides a method for communicating in a wireless communication network. The method includes receiving a message. The method further includes generating an acknowledgement message based on receiving the message. The acknowledgement message includes an acknowledgement of the received message. The method further includes transmitting the acknowledgment message based on a priority of the acknowledgment message. The priority of the acknowledgement message is that of control information. A priority of control information is above a priority of data.

In some aspects, the present disclosure provides a method for communicating in a wireless communication network. The method includes transmitting a message. The method further includes receiving a control protocol data unit (PDU) including a payload, the payload including an acknowledgement service data unit (SDU) of the transmitted message, in response to transmitting the message. The method further includes processing the control PDU at a lower layer based on a priority of the control PDU, wherein the priority of the control PDU is above a priority of data PDUs. The method further includes determining, based on the processing of the control PDU at the lower layer, that the payload of the control PDU includes an acknowledgement SDU. The method further includes forwarding the acknowledgement SDU to a higher layer, bypassing the lower layer. The method further includes processing the acknowledgment SDU at the higher layer.

In some aspects, the present disclosure provides an apparatus for communicating in a wireless communication network. The apparatus includes a memory and a processor coupled to the memory. The processor is further configured to receive a message. The processor is further configured to generate an acknowledgement message based on receiving the message. The acknowledgement message includes an acknowledgement of the received message. The processor is further configured to transmit the acknowledgment message based on a priority of the acknowledgment message. The priority of the acknowledgement message is that of control information. A priority of control information is above a priority of data.

In some aspects, the present disclosure provides an apparatus for communicating in a wireless communication network. The apparatus includes a memory and a processor coupled to the memory. The processor is configured to transmit a message. The processor is further configured to receive a control protocol data unit (PDU) including a payload, the payload including an acknowledgement service data unit (SDU) of the transmitted message, in response to transmitting the message. The processor is further configured to process the control PDU at a lower layer based on a priority of the control PDU, wherein the priority of the control PDU is above a priority of data PDUs. The processor is further configured to determine, based on the processing of the control PDU at the lower layer, that the payload of the control PDU includes an acknowledgement SDU. The processor is further configured to forward the acknowledgement SDU to a higher layer, bypassing the lower layer. The processor is further configured to process the acknowledgment SDU at the higher layer.

In some aspects, the present disclosure provides an apparatus for communicating in a wireless communication network. The apparatus includes means for receiving a message. The apparatus further includes means for generating an acknowledgement message based on receiving the message. The acknowledgement message includes an acknowledgement of the received message. The apparatus further includes means for transmitting the acknowledgment message based on a priority of the acknowledgment message. The priority of the acknowledgement message is that of control information. A priority of control information is above a priority of data.

In some aspects, the present disclosure provides an apparatus for communicating in a wireless communication network. The apparatus includes means for transmitting a message. The apparatus further includes means for receiving a control protocol data unit (PDU) including a payload, the payload including an acknowledgement service data unit (SDU) of the transmitted message, in response to transmitting the message. The apparatus further includes means for processing the control PDU at a lower layer based on a priority of the control PDU, wherein the priority of the control PDU is above a priority of data PDUs. The apparatus further includes means for determining, based on the processing of the control PDU at the lower layer, that the payload of the control PDU includes an acknowledgement SDU. The apparatus further includes means for forwarding the acknowledgement SDU to a higher layer, bypassing the lower layer. The apparatus further includes means for processing the acknowledgment SDU at the higher layer.

In some aspects, the present disclosure provides a computer readable medium having instructions stored thereon for causing at least one processor to perform a method. The method includes receiving a message. The method further includes generating an acknowledgement message based on receiving the message. The acknowledgement message includes an acknowledgement of the received message. The method further includes transmitting the acknowledgment message based on a priority of the acknowledgment message. The priority of the acknowledgement message is that of control information. A priority of control information is above a priority of data.

In some aspects, the present disclosure provides a computer readable medium having instructions stored thereon for causing at least one processor to perform a method. The method includes transmitting a message. The method further includes receiving a control protocol data unit (PDU) including a payload, the payload including an acknowledgement service data unit (SDU) of the transmitted message, in response to transmitting the message. The method further includes processing the control PDU at a lower layer based on a priority of the control PDU, wherein the priority of the control PDU is above a priority of data PDUs. The method further includes determining, based on the processing of the control PDU at the lower layer, that the payload of the control PDU includes an acknowledgement SDU. The method further includes forwarding the acknowledgement SDU to a higher layer, bypassing the lower layer. The method further includes processing the acknowledgment SDU at the higher layer.

Aspects generally include methods, apparatus, systems, computer readable mediums, and processing systems, as substantially described herein with reference to and as illustrated by the accompanying drawings.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed RAN, in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example BS and user equipment (UE), in accordance with certain aspects of the present disclosure.

FIG. 5 is a diagram showing examples for implementing a communication protocol stack, in accordance with certain aspects of the present disclosure.

FIG. 6 illustrates an example of a DL-centric subframe, in accordance with certain aspects of the present disclosure.

FIG. 7 illustrates an example of an UL-centric subframe, in accordance with certain aspects of the present disclosure.

FIG. 8 is a diagram illustrating an example acknowledgement (ACK) protocol data unit (PDU) according to some aspects of the present disclosure.

FIG. 9 is a diagram illustrating an example ACK PDU according to some aspects of the present disclosure.

FIG. 10 is a flowchart illustrating example operations for transmitting an ACK PDU according to some aspects of the present disclosure.

FIG. 11 is a flowchart illustrating example operations for processing an ACK PDU according to some aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for new radio (NR) (new radio access technology or 5G technology).

NR may support various wireless communication services, such as Enhanced mobile broadband (eMBB) targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra reliable low latency communications (URLLC). These services may include latency and reliability requirements. These services may also have different transmission time intervals (TTI) to meet respective quality of service (QoS) requirements. In addition, these services may co-exist in the same subframe.

Aspects of the present disclosure relate to techniques for prioritizing transmission and processing of ACKs. In particular, certain aspects relate to generating ACKs as payloads in control PDUs instead of as layer 2 ACKs or as payloads in data PDUs. In certain aspects, one or more ACK service data units (SDUs) (e.g., TCP ACK SDUs) are sent in a payload of a control PDU instead of sending the ACK SDUs as part of a data PDU. Including the ACK SDUs in a payload of a control PDU may speed up transmission of the ACK SDU at a device sending the control PDU and speed up processing of the ACK SDU at a device receiving the control PDU as compared to if the ACK SDU is included in a data PDU (e.g., if there are missing data PDUs in the transmission path between the devices). For example, at a device receiving the control PDU including a payload with an ACK SDU, the device may process the control PDU at a lower layer based on a priority of the control PDU that is higher than a priority of a data PDU. Based on such processing, the device may determine that the payload of the control PDU includes the acknowledgement SDU. Accordingly, the device may forward the ACK SDU to be processed by a higher layer, bypassing processing at the lower layer and therefore speeding up processing of the ACK SDU. Therefore, the ACK SDU may be an upper layer (e.g., PDCP) SDU instead of a lower layer (e.g., RLC) ACK.

Though certain aspects are discussed with respect to transmitting ACK service data units (SDUs) (e.g., TCP ACK SDUs) in a payload of a control PDU, and at a receiver processing such ACK SDUs, similar techniques may be applied to other types of SDUs or information included in the payload of a control PDU.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication networks such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). NR is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

### Example Wireless Communications System

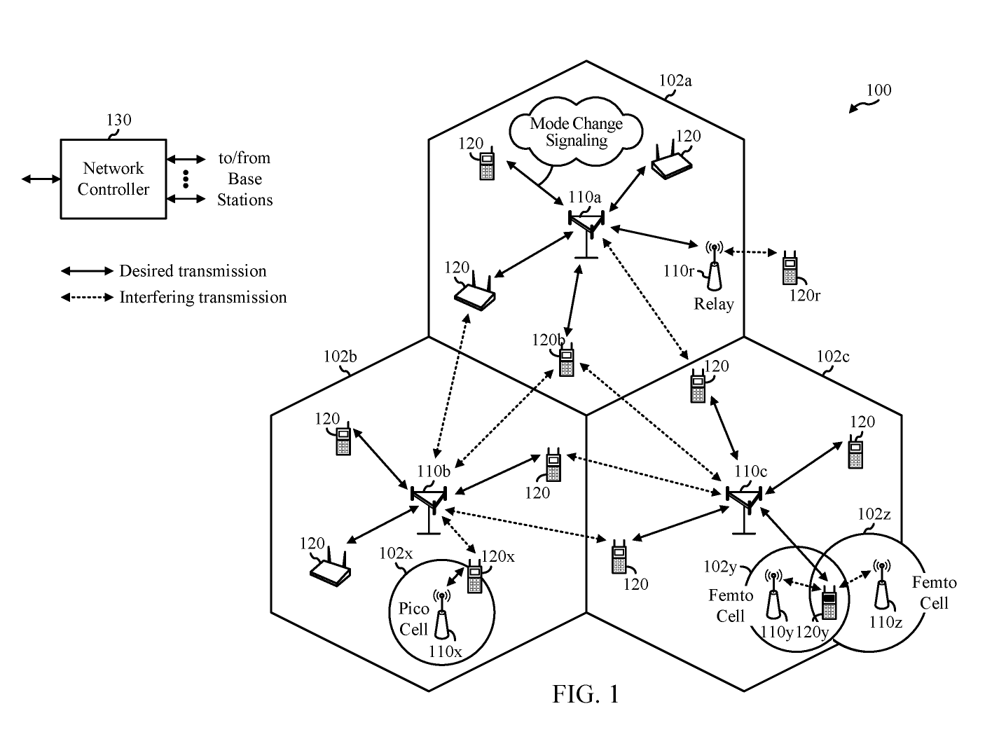

FIG. 1 illustrates an example wireless network 100, such as a new radio (NR) or 5G network, in which aspects of the present disclosure may be performed.

As illustrated in FIG. 1, the wireless network 100 may include a number of BSs 110 and other network entities. A BS may be a station that communicates with UEs. Each BS 110 may provide communication coverage for a particular geographic area. In 3GPP, the term “cell” can refer to a coverage area of a Node B and/or a Node B subsystem serving this coverage area, depending on the context in which the term is used. In NR systems, the term “cell” and eNB, gNB, gNodeB, Node B, 5G NB, AP, NR BS, NR BS, or TRP may be interchangeable. In some examples, a cell may not necessarily be stationary, and the geographic area of the cell may move according to the location of a mobile base station. In some examples, the base stations may be interconnected to one another and/or to one or more other base stations or network nodes (not shown) in the wireless network 100 through various types of backhaul interfaces such as a direct physical connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BS for the femto cells 102y and 102z, respectively. A BS may support one or multiple (e.g., three) cells.

The wireless network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

The wireless network 100 may be a heterogeneous network that includes BSs of different types, e.g., macro BS, pico BS, femto BS, relays, etc. These different types of BSs may have different transmit power levels, different coverage areas, and different impact on interference in the wireless network 100. For example, macro BS may have a high transmit power level (e.g., 20 Watts) whereas pico BS, femto BS, and relays may have a lower transmit power level (e.g., 1 Watt).

The wireless network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may be coupled to a set of BSs and provide coordination and control for these BSs. The network controller 130 may communicate with the BSs 110 via a backhaul. The BSs 110 may also communicate with one another, e.g., directly or indirectly via wireless or wireline backhaul.

The UEs 120 (e.g., 120x, 120y, etc.) may be dispersed throughout the wireless network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered evolved or machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices.

In FIG. 1, a solid line with double arrows indicates desired transmissions between a UE and a serving BS, which is a BS designated to serve the UE on the downlink and/or uplink. A dashed line with double arrows indicates interfering transmissions between a UE and a BS.

In certain aspects, as shown, a UE 120 or BS 110 may be configured to generate ACKs as payloads in control PDUs instead of as layer 2 ACKs or as payloads in data PDUs.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

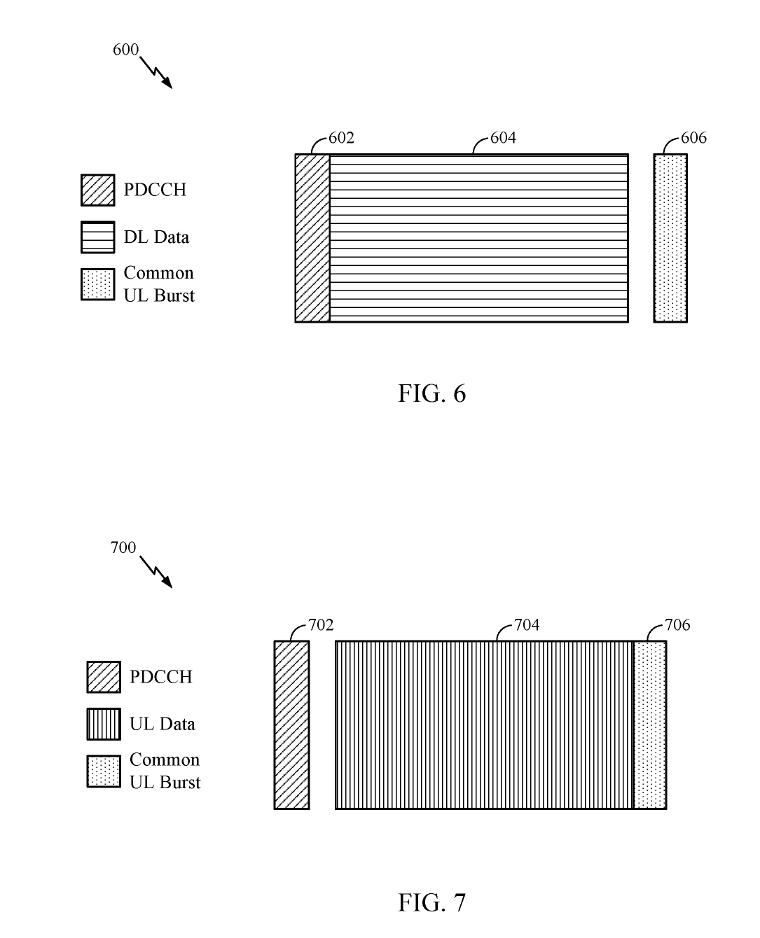

While aspects of the examples described herein may be associated with LTE technologies, aspects of the present disclosure may be applicable with other wireless communications systems, such as NR. NR may utilize OFDM with a CP on the uplink and downlink and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 ms duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 6 and 7. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based. NR networks may include entities such CUs and/or DUs.

In some examples, access to the air interface may be scheduled, wherein a scheduling entity (e.g., a base station) allocates resources for communication among some or all devices and equipment within its service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. That is, in some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may optionally communicate directly with one another in addition to communicating with the scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

As noted above, a RAN may include a CU and DUs. A NR BS (e.g., eNB, 5G Node B, Node B, transmission reception point (TRP), access point (AP)) may correspond to one or multiple BSs. NR cells can be configured as access cell (ACells) or data only cells (DCells). For example, the RAN (e.g., a central unit or distributed unit) can configure the cells. DCells may be cells used for carrier aggregation or dual connectivity, but not used for initial access, cell selection/reselection, or handover. In some cases DCells may not transmit synchronization signals—in some case cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

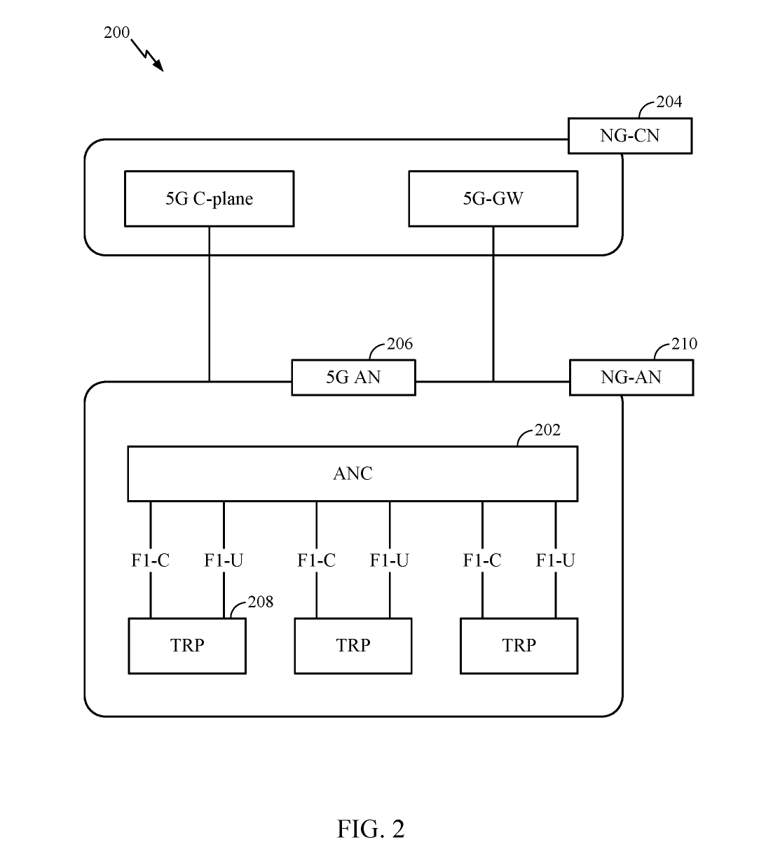

FIG. 2 illustrates an example logical architecture of a distributed radio access network (RAN) 200, which may be implemented in the wireless communication system illustrated in FIG. 1. A 5G access node 206 may include an access node controller (ANC) 202. The ANC may be a central unit (CU) of the distributed RAN 200. The backhaul interface to the next generation core network (NG-CN) 204 may terminate at the ANC. The backhaul interface to neighboring next generation access nodes (NG-ANs) may terminate at the ANC. The ANC may include one or more TRPs 208 (which may also be referred to as BSs, NR BSs, Node Bs, 5G NBs, APs, or some other term). As described above, a TRP may be used interchangeably with “cell.”

The TRPs 208 may be a DU. The TRPs may be connected to one ANC (ANC 202) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture 200 may be used to illustrate fronthaul definition. The architecture may be defined that support fronthauling solutions across different deployment types. For example, the architecture may be based on transmit network capabilities (e.g., bandwidth, latency, and/or jitter).

The architecture may share features and/or components with LTE. According to aspects, the next generation AN (NG-AN) 210 may support dual connectivity with NR. The NG-AN may share a common fronthaul for LTE and NR.

The architecture may enable cooperation between and among TRPs 208. For example, cooperation may be preset within a TRP and/or across TRPs via the ANC 202. According to aspects, no inter-TRP interface may be needed/present.

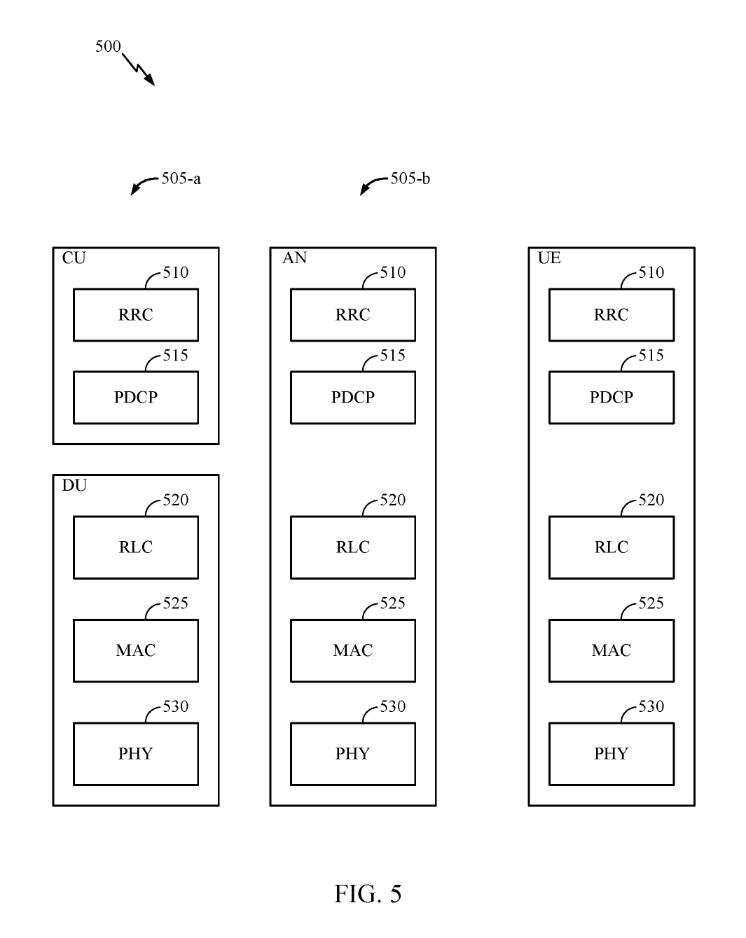

According to aspects, a dynamic configuration of split logical functions may be present within the architecture 200. As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU or CU (e.g., TRP or ANC, respectively). According to certain aspects, a BS may include a central unit (CU) (e.g., ANC 202) and/or one or more distributed units (e.g., one or more TRPs 208).

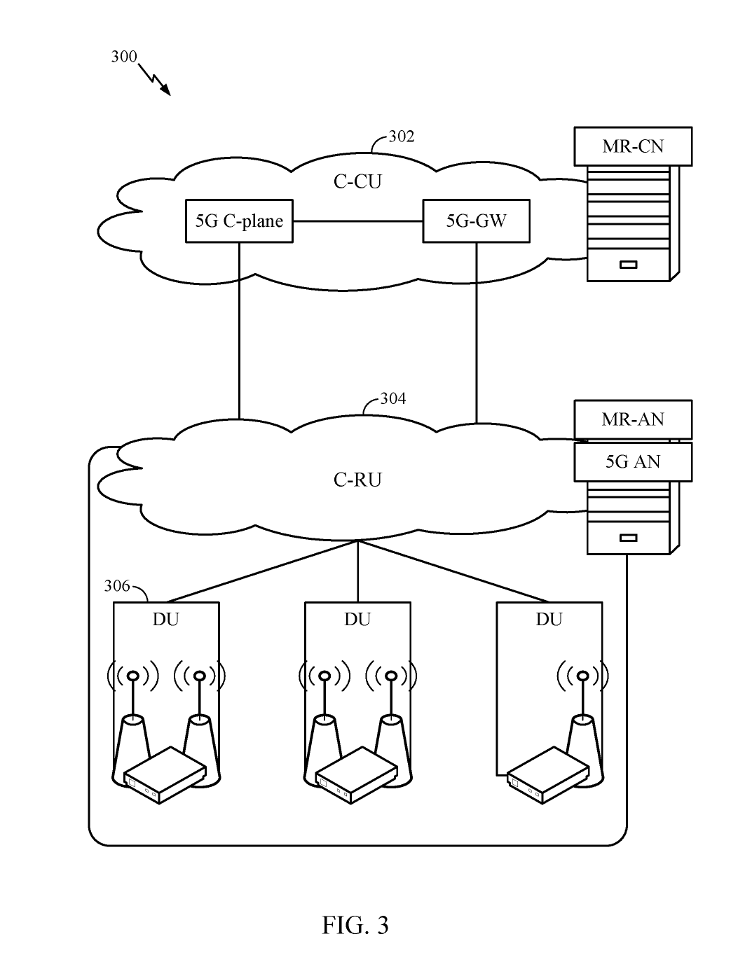

FIG. 3 illustrates an example physical architecture of a distributed RAN 300, according to aspects of the present disclosure. A centralized core network unit (C-CU) 302 may host core network functions. The C-CU may be centrally deployed. C-CU functionality may be offloaded (e.g., to advanced wireless services (AWS)), in an effort to handle peak capacity.

A centralized RAN unit (C-RU) 304 may host one or more ANC functions. Optionally, the C-RU may host core network functions locally. The C-RU may have distributed deployment. The C-RU may be closer to the network edge.

A DU 306 may host one or more TRPs (edge node (EN), an edge unit (EU), a radio head (RH), a smart radio head (SRH), or the like). The DU may be located at edges of the network with radio frequency (RF) functionality.

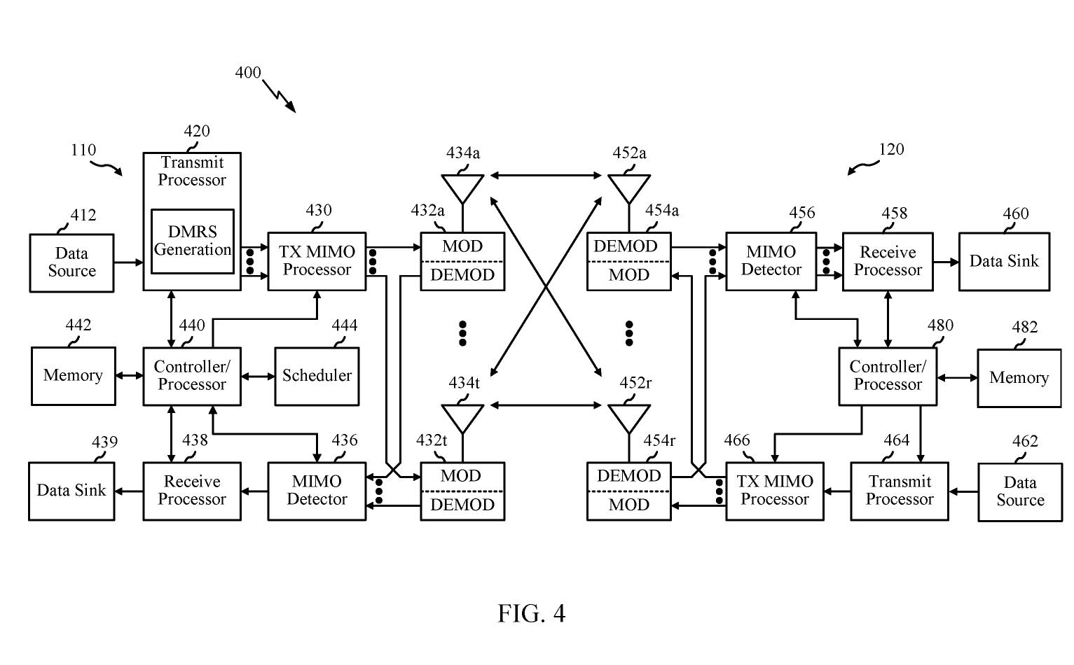

FIG. 4 illustrates example components of the BS 110 and UE 120 illustrated in FIG. 1, which may be used to implement aspects of the present disclosure. As described above, the BS may include a TRP. One or more components of the BS 110 and UE 120 may be used to practice aspects of the present disclosure. For example, antennas 452, Tx/Rx 222, processors 466, 458, 464, and/or controller/processor 480 of the UE 120 and/or antennas 434, processors 460, 420, 438, and/or controller/processor 440 of the BS 110 may be used to perform the operations described herein.

FIG. 4 shows a block diagram of a design of a BS 110 and a UE 120, which may be one of the BSs and one of the UEs in FIG. 1. For a restricted association scenario, the base station 110 may be the macro BS 110c in FIG. 1, and the UE 120 may be the UE 120y. The base station 110 may also be a base station of some other type. The base station 110 may be equipped with antennas 434a through 434t, and the UE 120 may be equipped with antennas 452a through 452r.

At the base station 110, a transmit processor 420 may receive data from a data source 412 and control information from a controller/processor 440. The control information may be for the Physical Broadcast Channel (PBCH), Physical Control Format Indicator Channel (PCFICH), Physical Hybrid ARQ Indicator Channel (PHICH), Physical Downlink Control Channel (PDCCH), etc. The data may be for the Physical Downlink Shared Channel (PDSCH), etc. The processor 420 may process (e.g., encode and symbol map) the data and control information to obtain data symbols and control symbols, respectively. The processor 420 may also generate reference symbols, e.g., for the PSS, SSS, DMRS, and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at the UE 120, a transmit processor 464 may receive and process data (e.g., for the Physical Uplink Shared Channel (PUSCH)) from a data source 462 and control information (e.g., for the Physical Uplink Control Channel (PUCCH) from the controller/processor 480. The transmit processor 464 may also generate reference symbols for a reference signal. The symbols from the transmit processor 464 may be precoded by a TX MIMO processor 466 if applicable, further processed by the demodulators 454a through 454r (e.g., for SC-FDM, etc.), and transmitted to the base station 110. At the BS 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

The controllers/processors 440 and 480 may direct the operation at the base station 110 and the UE 120, respectively. The processor 440 and/or other processors and modules at the base station 110 may perform or direct processes for the techniques described herein. The processor 480 and/or other processors and modules at the UE 120 may also perform or direct processes for the techniques described herein. The memories 442 and 482 may store data and program codes for the BS 110 and the UE 120, respectively. A scheduler 444 may schedule UEs for data transmission on the downlink and/or uplink.

FIG. 5 illustrates a diagram 500 showing examples for implementing a communications protocol stack, according to aspects of the present disclosure. The illustrated communications protocol stacks may be implemented by devices operating in a in a 5G system (e.g., a system that supports uplink-based mobility). Diagram 500 illustrates a communications protocol stack including a Radio Resource Control (RRC) layer 510, a Packet Data Convergence Protocol (PDCP) layer 515, a Radio Link Control (RLC) layer 520, a Medium Access Control (MAC) layer 525, and a Physical (PHY) layer 530. In various examples the layers of a protocol stack may be implemented as separate modules of software, portions of a processor or ASIC, portions of non-collocated devices connected by a communications link, or various combinations thereof. Collocated and non-collocated implementations may be used, for example, in a protocol stack for a network access device (e.g., ANs, CUs, and/or DUs) or a UE.

A first option 505-a shows a split implementation of a protocol stack, in which implementation of the protocol stack is split between a centralized network access device (e.g., an ANC 202 in FIG. 2) and distributed network access device (e.g., DU 208 in FIG. 2). In the first option 505-a, an RRC layer 510 and a PDCP layer 515 may be implemented by the central unit, and an RLC layer 520, a MAC layer 525, and a PHY layer 530 may be implemented by the DU. In various examples the CU and the DU may be collocated or non-collocated. The first option 505-a may be useful in a macro cell, micro cell, or pico cell deployment.

A second option 505-b shows a unified implementation of a protocol stack, in which the protocol stack is implemented in a single network access device (e.g., access node (AN), new radio base station (NR BS), a new radio Node-B (NR NB), a network node (NN), or the like.). In the second option, the RRC layer 510, the PDCP layer 515, the RLC layer 520, the MAC layer 525, and the PHY layer 530 may each be implemented by the AN. The second option 505-b may be useful in a femto cell deployment.

Regardless of whether a network access device implements part or all of a protocol stack, a UE may implement an entire protocol stack (e.g., the RRC layer 510, the PDCP layer 515, the RLC layer 520, the MAC layer 525, and the PHY layer 530).

FIG. 6 is a diagram 600 showing an example of a DL-centric subframe. The DL-centric subframe may include a control portion 602. The control portion 602 may exist in the initial or beginning portion of the DL-centric subframe. The control portion 602 may include various scheduling information and/or control information corresponding to various portions of the DL-centric subframe. In some configurations, the control portion 602 may be a physical DL control channel (PDCCH), as indicated in FIG. 6. The DL-centric subframe may also include a DL data portion 604. The DL data portion 604 may sometimes be referred to as the payload of the DL-centric subframe. The DL data portion 604 may include the communication resources utilized to communicate DL data from the scheduling entity (e.g., UE or BS) to the subordinate entity (e.g., UE). In some configurations, the DL data portion 604 may be a physical DL shared channel (PDSCH).

The DL-centric subframe may also include a common UL portion 606. The common UL portion 606 may sometimes be referred to as an UL burst, a common UL burst, and/or various other suitable terms. The common UL portion 606 may include feedback information corresponding to various other portions of the DL-centric subframe. For example, the common UL portion 606 may include feedback information corresponding to the control portion 602. Non-limiting examples of feedback information may include an ACK signal, a NACK signal, a HARQ indicator, and/or various other suitable types of information. The common UL portion 606 may include additional or alternative information, such as information pertaining to random access channel (RACH) procedures, scheduling requests (SRs), and various other suitable types of information. As illustrated in FIG. 6, the end of the DL data portion 604 may be separated in time from the beginning of the common UL portion 606. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 7 is a diagram 700 showing an example of an UL-centric subframe. The UL-centric subframe may include a control portion 702. The control portion 702 may exist in the initial or beginning portion of the UL-centric subframe. The control portion 702 in FIG. 7 may be similar to the control portion described above with reference to FIG. 6. The UL-centric subframe may also include an UL data portion 704. The UL data portion 704 may sometimes be referred to as the payload of the UL-centric subframe. The UL portion may refer to the communication resources utilized to communicate UL data from the subordinate entity (e.g., UE) to the scheduling entity (e.g., UE or BS). In some configurations, the control portion 702 may be a physical DL control channel (PDCCH).

As illustrated in FIG. 7, the end of the control portion 702 may be separated in time from the beginning of the UL data portion 704. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 706. The common UL portion 706 in FIG. 7 may be similar to the common UL portion 706 described above with reference to FIG. 7. The common UL portion 706 may additional or alternative include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example Acknowledgement Message Prioritization

In some aspects, wireless network 100 may support high data rates for communications on the UL and DL (e.g., 10 Gbps for the UL, 20 Gbps for the DL). Further, the wireless network may operate with low latency (e.g., 4 ms). Accordingly, in certain aspects, techniques herein provide reduced latency and increased throughput for communications on the UL and DL by reducing the latency for communicating ACKs between a transmitting entity (e.g., UE 120 or BS 110) and a receiving entity (e.g., BS 110 or UE 120) and for processing ACKs at the receiving entity.

In certain aspects, communication of data is described as different from communication of control information. In certain aspects, data may generally refer to the actual information (e.g., voice information, website information, etc.) to be communicated/shared between entities. Data may be sent in protocol data units (PDUs) designated as data PDUs. For example, the data may be sent in a payload of a PDU encapsulated with a header (e.g., layer-2 L2 header). The data PDU therefore carries the data as a payload. Control information may refer to information used to facilitate encoding, decoding, communication, etc. of the data. Control information may be sent in PDUs designated as control PDUs. As discussed, the control information may be sent in a payload of a PDU encapsulated with a header (e.g., L2 header). The control PDU therefore carries the control information as a payload. The payload itself is not at the L2 level. Rather the PDU is at the L2 level and includes a payload. Further, in certain aspects, certain techniques are discussed herein with respect to radio link control (RLC) as an example, however, these techniques may also be applicable to other protocols such as programme delivery control (PDC), media access control (MAC), etc. Further, in certain aspects, examples are given of data transmitted by a BS to a UE, and a UE transmitting an ACK in response to the BS. However, it should be noted that data may instead be transmitted by a UE to an BS, which responds with an ACK, between UEs, etc.

In one example, a transmitting entity (e.g., BS) may be transmitting data (e.g., transmission control protocol (TCP) data transmitted as PDUs) over a DL to a receiving entity (e.g., UE). The UE receiving the data may be configured to transmit an ACK (e.g., TCP ACK, other critical ACK, etc.) for data (e.g., each packet data unit (PDU)) received from the BS over an UL. The transmission of data (e.g., TCP flow of TCP data, sliding window management, etc.) by the BS may be dependent on whether ACKs are timely received by the BS from the UE. For example, if ACKs are delayed, then the transmission of data by the BS to the UE on the DL may be delayed.

In certain aspects, the UE may have an internal queue (e.g., buffer, watermark, memory, etc.) that queues data for transmission on the UL. The queue may be at the RLC layer and used for processing packets at the RLC layer. For example, the UE may have data (e.g., data PDUs) to transmit on the UL to the BS. In certain aspects, the UE may place ACKs for transmission on the UL in the same queue as the data to transmit on the UL. For example, in certain aspects, the ACKs may be sent in the same type of PDU (e.g., data PDU) as data for transmission on the UL to the BS. In certain aspects, the queue may be a first-in-first-out (FIFO) queue, and therefore, ACKs for transmission may be placed in the queue after data that is already pending for transmission on the UL. Accordingly, transmission of ACKs may be delayed until the data to transmit on the UL in the queue is transmitted first. Thus, reception of the ACKs by the BS may be delayed, and the overall transmission of data on the DL to the UE may be delayed.

In certain aspects, the UE may be configured to place ACKs for transmission ahead of data for transmission on the UL in the queue. Accordingly, ACKs may be transmitted before data for transmission on the UL. However, transmission of ACKs from the UE to the BS and processing of received ACKs at the BS may still be delayed, and therefore, the overall transmission of data on the DL to the UE may be delayed.

For example, some data PDUs transmitted from the UE to the BS on the UL may be lost during transmission (e.g., HARQ block error rate (BLER), RLC BLER, etc. may be present on the UL). The BS (e.g., acting as a RLC acknowledge mode (AM) entity) may be configured to process received data PDUs in sequence or in order (e.g., each PDU may have an associated sequence number). In particular, the BS at the RLC layer may process data PDUs in sequence or in order. Accordingly, the BS may need to wait until the lost data PDUs are retransmitted by the UE and received at the BS before the BS can process the received data PDUs. In aspects where ACKs are also transmitted as data PDUs, the data PDUs with the ACKs may not be processed at the BS, even if received by the BS, until data PDUs ahead of the ACK are properly received and processed in sequence. For example, the processing of the ACKs may be delayed by the round trip time (RTT) for retransmission of the lost data PDUs. Accordingly, the processing of ACKs may be delayed at the BS, and therefore the overall transmission of data on the DL to the UE may be delayed.

Further, where lost data PDUs are retransmitted as retransmission PDUs by the UE to the BS, the retransmission PDUs may be prioritized for transmission over the data PDUs. Accordingly, the transmission of ACKs in data PDUs may be delayed until the retransmission PDUs are transmitted on the UL, and therefore the overall transmission of data on the DL to the UE may be delayed.

In certain aspects, transmission and processing of control information (e.g., control PDUs) and retransmissions of data (e.g., retransmission PDUs) may be prioritized over transmission and processing of data (e.g., data PDUs). Accordingly, in certain aspects, techniques disclosed herein provide for prioritizing transmission and processing of ACKs over data by including the ACKs (e.g., ACK SDU(s) such as TCP ACK SDUs) as a payload in a control PDU classified as control information. In particular, certain aspects relate to generating ACKs in control PDUs instead of data PDUs. It should be noted that this is different than ACKs made at the L2 level itself, such as ACKs that piggyback on control information being sent from a UE to a BS or vice versa, as the ACK is included as payload in the control PDU, as opposed to as control information at the L2 level.

For example, in certain aspects (e.g., in RLC), control PDUs are processed (e.g., at the RLC layer) upon arrival. Accordingly, a BS receiving a control PDU on an UL from a UE may process the control PDU immediately (e.g., before processing data PDUs, waiting for PDUs to arrive in sequence before processing, etc.). For example, in certain aspects, the BS may have separate queues for processing control PDUs and data PDUs. Therefore, the BS processes a control PDU upon arrival, and therefore does not delay transmission of data to the UE on the DL due to delays in ACK processing. In certain aspects, the BS processes the control PDU at the RLC layer, determines that the payload of the control PDU is an ACK SDU, and then pushes the ACK SDU for immediate processing to a higher layer (e.g., PDCP) instead of putting the ACK SDU in a queue at the RLC layer for processing.

Further, in certain aspects (e.g., in RLC), control PDUs may be transmitted before data PDUs. Accordingly, a UE transmitting a control PDU on an UL to a BS may transmit the control PDU ahead of any pending data PDUs. For example, in certain aspects, the UE may have separate queues for transmission of control PDUs and data PDUs. Therefore, the UE does not delay transmission of ACKs to the BS based on pending data PDUs, and the BS timely receives ACKs. Thus, the BS does not delay transmission of data to the UE on the DL due to delays in receiving ACKs.

In certain aspects, a PDU may include a payload portion (e.g., for data, control information, an ACK, etc.) and a header portion that describes or is used to process the payload. In certain aspects, the header portion includes a fixed portion that is included in each PDU and an extension portion that is only included in the header when utilized. In certain aspects, a control PDU with an ACK as a payload may be referred to as an ACK PDU (e.g., TCP ACK PDU). In certain aspects, an ACK PDU may include one ACK (e.g., ACK SDU) in its payload, or multiple ACKs (e.g., ACK SDUs) in its payload.

In certain aspects, a fixed portion of a header of a PDU includes a data/control (D/C) field (e.g., 1 bit). A value of the D/C field may indicate if a PDU is a data PDU or a control PDU. For example, a value of 0 may indicate the PDU is a control PDU (e.g., ACK PDU), and a value of 1 may indicate the PDU is a data PDU. In certain aspects, for ACK PDUs, the value of the D/C field may indicate the PDU is a control PDU (e.g., have a value of 0).

In certain aspects, the fixed portion of the header of a control PDU may include a control PDU type (CPT) field (e.g., 3 bits). In certain aspects, for ACK PDUs, the value of the CPT field may indicate that the control PDU is an ACK PDU. For example, a value of 001 of the CPT field may indicate the control PDU is an ACK PDU. Other values of the CPT field may indicate the control PDU is of a different type (e.g., 000 may indicate the control PDU is a status PDU) or may be reserved. For example, if a BS receives a control PDU and determines the CPT field indicates the control PDU is an ACK PDU, the lower layer (e.g., RLC layer) of the BS may forward the payload (e.g., ACK SDU(s)) of the control PDU to a higher layer (e.g., PDCP layer) for immediate processing.

In certain aspects, the fixed portion of the header of an ACK PDU may include an extension (E) field (e.g., 1 bit). In certain aspects, The E field may indicate whether a payload follows the E field or sets of additional E fields and length indicator (LI) fields (e.g., corresponding to an extension portion of the header of the ACK PDU). For example, in certain aspects, a value of 0 of the E field indicates that a payload follows the E field. In certain aspects, a value of 1 of the E field indicates that sets of additional E fields and length indicator LI fields follow the E field.

For example, if the ACK PDU includes only one ACK in the payload, then the E field may be 0, and the data following the E field may correspond to the ACK. If the ACK PDU includes multiple ACKs in the payload, then the ACK PDU may include an E field and LI field for each ACK in the payload, except for the last ACK in the payload. The LI field may indicate the length (e.g., in bits) of each part of the payload (e.g., the length of each ACK). In certain aspects, the LI field may be 11 bits. In certain aspects the LI field is 15 bits. In certain aspects, where an ACK PDU includes multiple ACKS, padding bits may be used after the last LI field in the ACK PDU for byte alignment of the header. For example, wherein the LI field has a length of 15 bits, or there are an even number of LI fields and the LI field has a length of 11 bits, four padding bits may follow the last LI field.

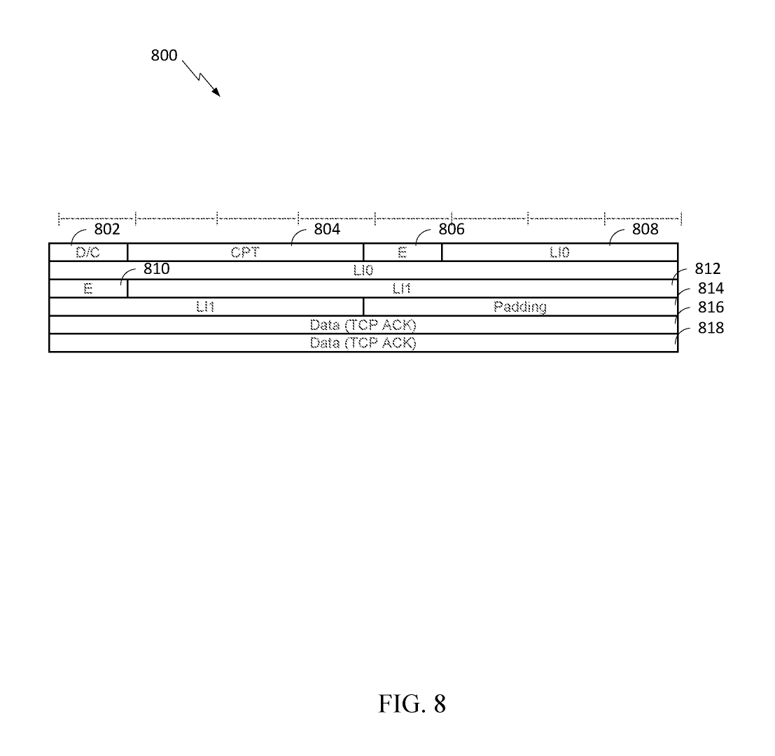

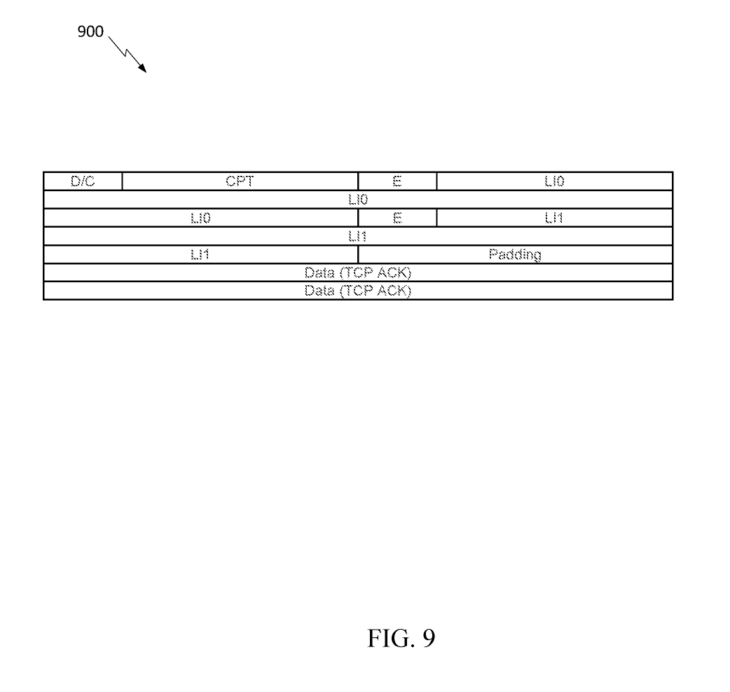

FIG. 8 is a diagram illustrating an example ACK PDU 800 according to some aspects of the present disclosure. Each row of the ACK PDU 800 as illustrates corresponds to an octet (8-bits) of the ACK PDU 800. As shown, the ACK PDU 800 includes a D/C field 802, a CPT field 804, and a first E field 806. The ACK PDU 800 further includes a first ACK 816 and a second ACK 818. The value (e.g., 0) of the D/C field 802 indicates that the ACK PDU 800 is a control PDU type. The value (e.g., 001) of the CPT field 804 indicates that the ACK PDU 800 is an ACK PDU type.

Since the ACK PDU 800 includes multiple ACKs (e.g., ACK SDUs), the ACK PDU 800 includes a first E field 806, a first LI field 808, a second E field 810, and a second LI field 812. Accordingly, there is an E field and an LI field for each of the two ACKs 816 and 818. The value (e.g. 1) of the first E field 806 may be set to indicate that additional sets of E fields and LI fields follow the first E field 806. The value (e.g., 0) of the second E field 810 may be set to indicate that there are no additional sets of E fields and LI fields (i.e., only one LI field) to follow the second E field 810. The value of the first LI field 808 indicates the length of the first ACK 816. The value of the second LI field 812 indicates the length of the second ACK 818. In certain aspects, each of the first LI field 808 and the second LI field 812 may have a length of 11 bits. Accordingly, the ACK PDU 800 includes padding bits 814 (e.g., 4 bits) after the second LI field 812 to ensure the octets of the header portion (first four rows as shown) align. The payload including the ACKs 816 and 818 follow the padding bits 814.

FIG. 9 is a diagram illustrating an example ACK PDU 800 according to some aspects of the present disclosure. As shown, ACK PDU 800 is similar to ACK PDU 800. However, in ACK PDU 900, each of the LI fields are 15 bits long.

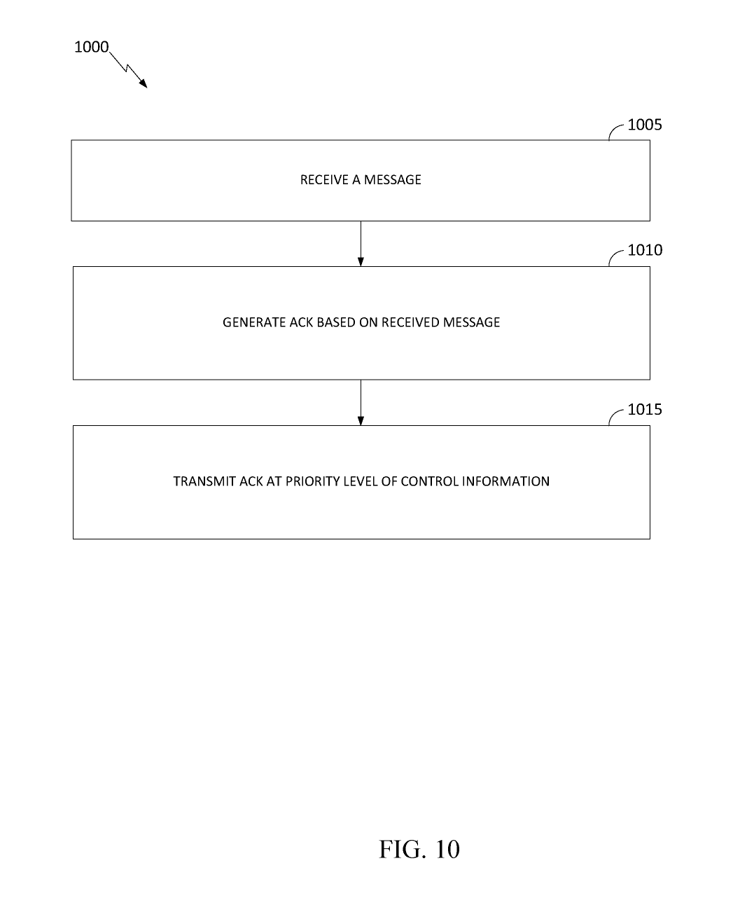

FIG. 10 is a flowchart illustrating example operations 1000 for transmitting an ACK PDU according to some aspects of the present disclosure. At 1005, a message is received. For example, a receiving entity (e.g., UE or BS) may receive a message (e.g., data, PDU, etc.) from a transmitting entity (e.g., BS or UE). Further, at 1010, the receiving entity generates an acknowledgement message based on receiving the message from the transmitting entity. For example, the receiving entity may generate an acknowledgement message (e.g., ACK PDU) including an ACK (e.g., ACK SDU) for the received message. The acknowledgement message may include an indicator that the acknowledgement message is to be transmitted and processed as control information. In certain aspects, the receiving entity generates a control PDU including an ACK SDU as the payload of the control PDU.

At 1015, the receiving entity transmits the acknowledgement message to the transmitting entity based on a priority of the acknowledgement message. In particular, the priority of the acknowledgement message may be that of control information (e.g., where the acknowledgment message is a control PDU as discussed), which is above a priority of data (e.g., data PDU). For example, the receiving entity may have a queue for control information (e.g., control PDUs) and a separate queue for data (e.g., data PDUs) and prioritize transmission of control information over data.

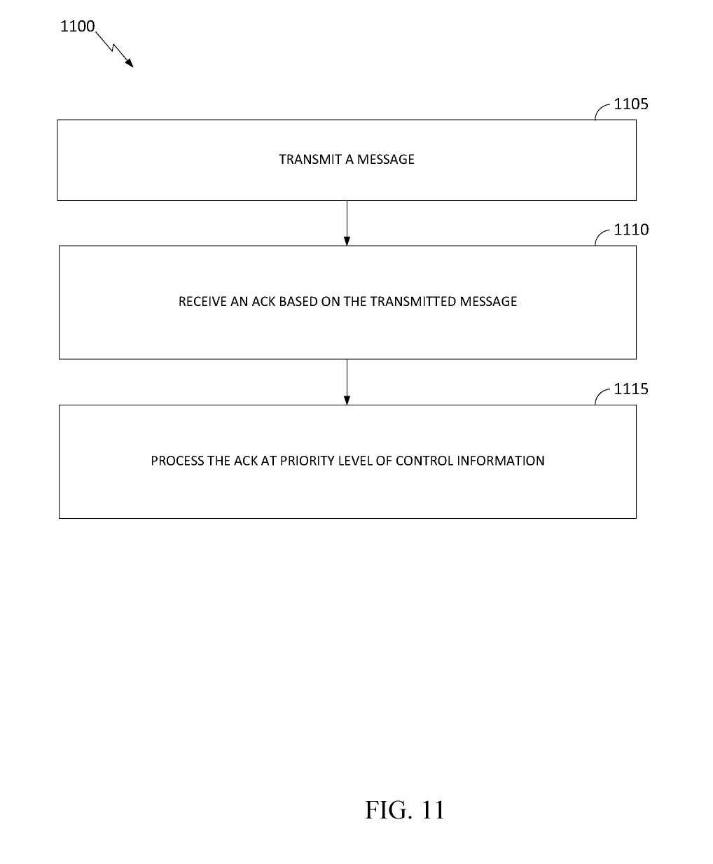

FIG. 11 is a flowchart illustrating example operations for processing an ACK PDU according to some aspects of the present disclosure. At 1105, a message is transmitted. For example, a transmitting entity (e.g., BS or UE) may transmit a message (e.g., data, PDU, etc.) to a receiving entity (e.g., UE or BS). Further, at 1110, the transmitting entity receives an acknowledgement message from the receiving entity based on transmitting the message to the receiving entity. For example, the receiving entity may generate and send to the transmitting entity an acknowledgement message (e.g., ACK PDU) including an ACK for the transmitted message. The acknowledgement message may include an indicator that the acknowledgement message is to be processed as control information. The acknowledgement message may be a control PDU including an ACK as the payload of the control PDU. For example, the transmitting entity may receive a control protocol data unit (PDU) including a payload, the payload including an acknowledgement service data unit (SDU) of the transmitted message, in response to transmitting the message.

At 1115, the transmitting entity processes the acknowledgement message based on a priority of the acknowledgement message. In particular, the priority of the acknowledgement message may be that of control information, which is above a priority of data. For example, the transmitting entity may have a queue for control information (e.g., control PDUs) and a separate queue for data (e.g., data PDUs) and prioritize processing of control information over data. For example, the transmitting entity may process the control PDU at a lower layer (e.g., RLC layer) based on a priority of the control PDU, wherein the priority of the control PDU is above a priority of data PDUs. The transmitting entity may further determine, based on the processing of the control PDU at the lower layer, that the payload of the control PDU includes an acknowledgement SDU. The transmitting entity may further forward the acknowledgement SDU to a higher layer (e.g., PDCP layer), bypassing the lower layer. The transmitting entity may further process the acknowledgment SDU at the higher layer.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for transmitting and/or means for receiving may comprise one or more of a transmit processor 420, a TX MIMO processor 430, a receive processor 438, or antenna(s) 434 of the base station 110 and/or the transmit processor 464, a TX MIMO processor 466, a receive processor 458, or antenna(s) 452 of the user equipment 120. Additionally, means for generating, means for allocating, and/or means for including may comprise one or more processors, such as the controller/processor 440 of the base station 110 and/or the controller/processor 480 of the user equipment 120.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for communicating in a wireless communication network, the method comprising:
transmitting a message;
receiving a control protocol data unit (PDU) including a payload, the payload including an acknowledgement service data unit (SDU) of the transmitted message, in response to transmitting the message;
processing the control PDU at a lower layer based on a priority of the control PDU, wherein the priority of the control PDU is above a priority of data PDUs;
determining, based on the processing of the control PDU at the lower layer, that the payload of the control PDU includes an acknowledgement SDU;
forwarding the acknowledgement SDU to a higher layer, bypassing the lower layer; and
processing the acknowledgment SDU at the higher layer.

2. The method of claim 1, wherein a header of the control PDU comprises a plurality of fields, wherein a first field of the plurality of fields indicates the priority level of the control PDU.

3. The method of claim 1, wherein the control PDU comprises a plurality of acknowledgement SDUs of a plurality of transmitted messages.

4. The method of claim 1, further comprising:
maintaining a first queue for processing control PDUs at the lower layer and a second queue for processing data PDUs at the lower layer; and
placing the control PDU in the first queue.

5. The method of claim 1, wherein a header of the control PDU comprises a plurality of fields, wherein the plurality of fields comprises a control packet data unit type field, and wherein a value of the control packet data unit type field of the control PDU indicates the control PDU is of an acknowledgement type.

6. The method of claim 1, wherein a header of the control PDU comprises an extension field and a length indicator field.

7. The method of claim 1, wherein a header of the control PDU comprises a data/control field that indicates that the control PDU is a control message.

8. An apparatus for communicating in a wireless communication network, the apparatus comprising:
a memory; and
a processor coupled to the memory, the processor being configured to:
transmit a message;
receive a control protocol data unit (PDU) including a payload, the payload including an acknowledgement service data unit (SDU) of the transmitted message, in response to transmitting the message;
process the control PDU at a lower layer based on a priority of the control PDU, wherein the priority of the control PDU is above a priority of data PDUs;
determine, based on the processing of the control PDU at the lower layer, that the payload of the control PDU includes an acknowledgement SDU;
forward the acknowledgement SDU to a higher layer, bypassing the lower layer; and
process the acknowledgment SDU at the higher layer.

9. The apparatus of claim 8, wherein a header of the control PDU comprises a plurality of fields, wherein a first field of the plurality of fields indicates the priority level of the control PDU.

10. The apparatus of claim 8, wherein the control PDU comprises a plurality of acknowledgement SDUs of a plurality of transmitted messages.

11. The apparatus of claim 8, wherein the processor is further configured to:
maintain a first queue for processing control PDUs at the lower layer and a second queue for processing data PDUs at the lower layer; and
place the control PDU in the first queue.

12. The apparatus of claim 8, wherein a header of the control PDU comprises a plurality of fields, wherein the plurality of fields comprises a control packet data unit type field, and wherein a value of the control packet data unit type field of the control PDU indicates the control PDU is of an acknowledgement type.

13. The apparatus of claim 8, wherein a header of the control PDU comprises an extension field and a length indicator field.

14. The apparatus of claim 8, wherein a header of the control PDU comprises a data/control field that indicates that the control PDU is a control message.

15. An apparatus for communicating in a wireless communication network, the apparatus comprising:
means for transmitting a message;
means for receiving a control protocol data unit (PDU) including a payload, the payload including an acknowledgement service data unit (SDU) of the transmitted message, in response to transmitting the message;
means for processing the control PDU at a lower layer based on a priority of the control PDU, wherein the priority of the control PDU is above a priority of data PDUs;
means for determining, based on the processing of the control PDU at the lower layer, that the payload of the control PDU includes an acknowledgement SDU;
means for forwarding the acknowledgement SDU to a higher layer, bypassing the lower layer; and
means for processing the acknowledgment SDU at the higher layer.

16. The apparatus of claim 15, wherein a header of the control PDU comprises a plurality of fields, wherein a first field of the plurality of fields indicates the priority level of the control PDU.

17. The apparatus of claim 15, wherein the control PDU comprises a plurality of acknowledgement SDUs of a plurality of transmitted messages.

18. The apparatus of claim 15, further comprising:
means for maintaining a first queue for processing control PDUs at the lower layer and a second queue for processing data PDUs at the lower layer; and
means for placing the control PDU in the first queue.

19. The apparatus of claim 15, wherein a header of the control PDU comprises a plurality of fields, wherein the plurality of fields comprises a control packet data unit type field, and wherein a value of the control packet data unit type field of the control PDU indicates the control PDU is of an acknowledgement type.

20. The apparatus of claim 15, wherein a header of the control PDU comprises an extension field and a length indicator field.

21. The apparatus of claim 15, wherein a header of the control PDU comprises a data/control field that indicates that the control PDU is a control message.

22. A computer readable medium having instructions stored thereon for causing at least one processor to perform a method, the method comprising:
transmitting a message;
receiving a control protocol data unit (PDU) including a payload, the payload including an acknowledgement service data unit (SDU) of the transmitted message, in response to transmitting the message;
processing the control PDU at a lower layer based on a priority of the control PDU, wherein the priority of the control PDU is above a priority of data PDUs;
determining, based on the processing of the control PDU at the lower layer, that the payload of the control PDU includes an acknowledgement SDU;
forwarding the acknowledgement SDU to a higher layer, bypassing the lower layer; and
processing the acknowledgment SDU at the higher layer.

23. The computer readable medium of claim 22, wherein a header of the control PDU comprises a plurality of fields, wherein a first field of the plurality of fields indicates the priority level of the control PDU.

24. The computer readable medium of claim 22, wherein the control PDU comprises a plurality of acknowledgement SDUs of a plurality of transmitted messages.

25. The computer readable medium of claim 22, wherein the method further comprises:
maintaining a first queue for processing control PDUs at the lower layer and a second queue for processing data PDUs at the lower layer; and
placing the control PDU in the first queue.

26. The computer readable medium of claim 22, wherein a header of the control PDU comprises a plurality of fields, wherein the plurality of fields comprises a control packet data unit type field, and wherein a value of the control packet data unit type field of the control PDU indicates the control PDU is of an acknowledgement type.

27. The computer readable medium of claim 22, wherein a header of the control PDU comprises an extension field and a length indicator field.

28. The computer readable medium of claim 22, wherein a header of the control PDU comprises a data/control field that indicates that the control PDU is a control message.
